(19) United States
(12) Patent Application Publication
(10) Pub. No.: US 2018/0180340 A1
(43) Pub. Date: Jun. 28, 2018

(54) DYNAMIC POWER SENSING SYSTEM

(71) Applicant: Wal-Mart Stores, Inc., Bentonville, AR (US)

(72) Inventors: Nicholaus Adam Jones, Fayetteville, AR (US); Matthew Allen Jones, Bentonville, AR (US); Aaron James Vasgaard, Rogers, AR (US)

(21) Appl. No.: 15/849,758

(22) Filed: Dec. 21, 2017

Related U.S. Application Data
(60) Provisional application No. 62/438,765, filed on Dec. 23, 2016.

(51) Int. Cl. F25B 49/02; F25B 49/00; F04B 49/06; H02J 13/00

(52) U.S. Cl. CPC F25B 49/027; F25B 49/005; F04B 49/065; F25D 2700/12; F25B 2400/06; F25B 2700/15; H02J 13/0086

(57) ABSTRACT

Systems, methods and apparatuses for monitoring the activity temperature controlled compartments of a refrigeration system by monitoring the activity of the compressor as the compressor changes between the ON or OFF state. In particular, the disclosure describes systems methods and tools for measuring the electrical loads drawn by the compressor for the purpose of predicting and determining the occurrence of unknown events from the energy profile of the compressors. One or more specialized computer systems may be connected between the compressor circuit and an energy source in order to monitor and track the amounts of energy being delivered to the compressor. The specialized computer systems measuring and tracking the electrical load supplied to the compressor may characterize the electrical load supplied as having one or more energy profiles. Each of the energy profiles may correspond to different types of events resulting in the consumption of energy by the compressor.

### CROSS REFERENCE TO RELATED APPLICATIONS

This application claims priority and benefit of U.S. Patent Application No. 62/438,765 entitled DYNAMIC POWER SENSING SYSTEM, filed on Dec. 23, 2016, the contents of which are hereby incorporated by reference.

### TECHNICAL FIELD

The present disclosure relates generally to systems, methods and apparatuses for monitoring the activity of temperature controlled storage devices.

### BACKGROUND

Refrigeration equipment is widely used to preserve the quality and shelf-life of many commercially valuable products. The products preserved are principally food but other valuable items such as blood, plasma and other tissues may also be maintained with the refrigeration equipment. Today, most stores, particularly those in the grocery business have some type of refrigeration equipment maintaining products at a cooled temperature. Generally, the sale of meat and dairy products without adequate refrigeration is prohibited by regulation. Refrigeration equipment may be located dose to the origin of the foodstuffs for temporary storage or during the transportation of the foodstuffs. For example, inside refrigerated trucks, warehouses or storage depots.

The most widely-used refrigeration systems rely on the cooling provided by an evaporator located within the space desired to be cooled or in thermal communication with the space to be cooled. Cooling inside the temperature controlled storage compartment is performed by the rapid expansion of gas. A refrigerant gas is contained in a sealed conduit forming a closed loop. A compressor compresses the refrigerant in its gaseous phase into a condenser. The compression causes a heating of the refrigerant, and that heat is drawn away by a stream of air or water flowing over a heat exchanger associated with the condenser. This loss of heat causes the refrigerant to liquefy. Liquid refrigerant is released through an expansion valve downstream of the condenser into an evaporator wherein the pressure is lower than the region upstream of the expansion valve. In the evaporator, vaporization of the liquid and expansion of the gas occurs. This expansion and vaporization require energy, which is taken as heat from the walls and surroundings of the evaporator, causing a cooling in the vicinity of the evaporator (including cooling of any chamber or the like with which the evaporator is in thermal communication). To facilitate heat exchange, the evaporator is provided with a heat exchanger, cooling fins, and a fan is typically used to maintain a stream of air over the evaporator. The evaporator accepts heat from the air stream, reducing its temperature. The cool air produced is circulated by the fan within the chamber to be cooled.

Typically, refrigeration systems are controlled either by one or more thermostats located in the temperature controlled compartment being cooled or by a sensor measuring the refrigerant pressure in the evaporator. When one or more of these sensors indicates that the temperature or evaporator pressure has risen sufficiently to exceed an appropriate selected upper threshold, the compressor is activated, and cooling begins. Cooling continues until either a selected lower temperature limit is reached or the pressure inside the evaporator has fallen sufficiently. Accordingly, once the desired temperature is reached, the compressor is turned off. Generally, the compressor's “ON” and “OFF” cycles occur at regular and predictable intervals, except when the refrigerator is opened to permit insertion or removal of the refrigerator's contents.

### SUMMARY

A first embodiment of the present disclosure provides a method for monitoring activity of a temperature controlled compartment comprising the steps of: connecting a computer system to an electrical conduit powering the temperature controlled compartment; establishing, by the computer system, a baseline electrical load of a compressor maintaining the temperature controlled device at a baseline temperature; receiving, by the computer system, a measurement of an amount of electrical load sent to the compressor; detecting, by the computing system, an increase in the amount of electrical load sent to the compressor above the baseline electrical load; analyzing, by the computer system, the increase in the amount of electrical load sent to the compressor to identify a known energy profile or pattern correlating to a known type of event and calculating a length of time of the increase in the amount of electrical load; and determining, by the computer system, a type of an event causing the increase in the amount of electrical load sent to the compressor as a function of the analyzing step.

A second embodiment of the present disclosure provides a computer system comprising a processor; a memory device coupled to the processor; a sensor device, coupled to the processor; al electrical conduit coupled to the sensor device; a compressor coupled to the electrical conduit; a temperature controlled compartment coupled to the compressor and a computer readable storage device coupled to the processor, wherein the storage device comprises program code executable by the processor via the memory device to implement a method for monitoring the activity of the temperature controlled compartment comprising the steps of: establishing, by the processor, a baseline electrical load of a compressor maintaining the temperature controlled device at a baseline temperature; receiving, by the processor, a measurement taken by the sensor device measuring an amount of electrical load sent to the compressor; detecting, by the processor, an increase in the amount of electrical load sent to the compressor above the baseline electrical load; analyzing, by the computer system, the increase in the amount of electrical load sent to the compressor to identify a known energy profile or pattern correlating to a known type of event and calculating a length of time of the increase in the amount of electrical load; and concluding, by the processor, a type of an event causing the increase in the amount of electrical load sent to the compressor as a function of the analyzing step.

### BRIEF DESCRIPTION OF THE DRAWINGS

FIG. 1 depicts a schematic diagram of an embodiment of system for monitoring the activity of a temperature controlled compartment.

FIG. 2 depicts a block diagram of the system for monitoring the activity of a temperature controlled compartment of FIG. 1.

FIG. 3 depicts a schematic diagram of an alternative embodiment of a system for monitoring the activity of a temperature controlled compartment.

FIG. 4 illustrates a schematic diagram of another alternative embodiment of a system for monitoring a temperature controlled compartment.

FIG. 5 depicts a block diagram of a system for monitoring the activity of a temperature controlled compartment depicted in either FIG. 3 or 4.

FIG. 6a depicts a graphical representation of an embodiment of an energy profile describing an event causing an increase in the amount of electrical load sent to a compressor of the system for monitoring the activity of a temperature controlled compartment.

FIG. 6b depicts a graphical representation of an embodiment of an alternative energy profile describing an alternative event causing an increase in the amount of electrical load sent to a compressor of the system for monitoring the activity of a temperature controlled compartment.

FIG. 6c depicts a graphical representation of an embodiment of second alternative energy profiled describing a second alternative event causing an increase in the amount of electrical load sent to a compressor of the system for monitoring the activity of a temperature controlled compartment.

FIG. 7 depicts an embodiment of an algorithm for implementing a method for monitoring the activity of a temperature controlled compartment.

FIG. 8 depicts an embodiment of a computer system implementing the method for monitoring the activity of a temperature controlled compartment, consistent with the embodiments disclosed in this application.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features. As a preface to the detailed description, it should be noted that, as used in this specification and the appended claims, the singular forms “a”, “an” and “the” include plural referents, unless the context clearly dictates otherwise.

### Overview

Refrigeration systems may sometimes have one or more temperature controlled compartments that utilize thermostats or sensors to detect changes in the environment of the compartment. As the temperature inside of the compartment or pressure inside the evaporator rises, the compressor may be placed into the “ON” state in order to reduce the temperature back to a set baseline temperature. Subsequently, once the appropriate temperature or pressure is achieved, the compressor is returned to the “OFF” state. As the compressor shifts from the OFF state to the ON state, the compressor is energized by a specific amount of electrical energy, activating the compressor. Different interactions between individuals and the refrigeration system may impact the frequency and length of the compressor's activity in the ON state. For instance, opening and/or closing the compartment door for the purpose of delivering products may affect the compressor's response differently than opening the compartment door briefly to remove a single item contained therein. Currently available refrigeration systems are unable to decipher the length and frequency of activating the compressor to predict or identify the types of activity and events experienced by the refrigeration system.

Embodiments of present disclosure improve upon temperature controlled refrigeration systems and methods for monitoring the activity of the temperature controlled compartments therein, including temperature controlled compartments refrigerated by freezers, coolers and refrigerators. Specifically, the embodiments of the present disclosure monitor the activity of the compressor as the compressor changes between the ON or OFF state by measuring the electrical load supplied to the compressor. One or more specialized computer systems may be connected between the compressor circuit and an energy source in order to monitor and track the amounts of energy being delivered to the compressor. The specialized computer systems measuring and tracking the electrical load supplied to the compressor may characterize the electrical load supplied as having one or more energy profiles. Each of the energy profiles may correspond to different types of events resulting in the consumption of energy by the compressor. Embodiments of the computer systems tracking and monitoring energy consumption may compare energy profiles that have been previously calibrated for known events with the current energy delivery to the compressor. The computer systems measuring and tracking the energy delivery and consumption may identify the type of event occurring based on the similarities between the known energy profiles and the pattern of the electrical load delivered to the compressor circuit.

The identification of the various types of events by comparing known energy profiles with the current condition may provide useful information to users tracking the activity of the refrigeration systems. Tracking the patterns of energy being supplied to the compressors may be useful for confirming the completion of scheduled events, tracking customer behavior and diagnosing technical issues with the refrigeration equipment. For example, deliveries may be a commonly scheduled event, particularly at retail and grocery stores. Deliveries may be performed by leaving the door to a temperature controlled compartment open for an extended period of time as the temperature controlled compartment is restocked with new or replacement contents. By leaving the door open for an extended length of time, the compressor my run for a longer length of time or more frequently and may therefore display a uniquely long energy profile as measured by the computer system. Likewise, once the delivery profile has been identified, the computer system may confirm whether or not the delivery has indeed arrived using the energy profiles to confirm an employee interaction with the refrigeration system.

Similarly, customer activity, such as opening or closing the doors to the temperature controlled compartments may result in a distinctly different energy profile than the delivery profile. Customer interactions may be a series of short, quick, opening and closings of the door, rather than leaving the door open for an extended period of time which results in a greater amount of heat exposure. Moreover, customer interactions may be random, inconsistent and sporadic. The computer system of the present disclosure may be able to identify individual, isolated customer interactions, as well as bursts of consecutive customer interactions. The computer system may use the various sporadic customer interactions to identify trends. For instance, an increased volume of customers interacting with the refrigeration system may be indicative of busier store times, successful specials or desirable products. Accordingly, by monitoring the activity of the refrigeration system, stores may better understand customer trends, buying habits within the store and stock or coordinate the store's layout in response to the trends.

Furthermore, with respect to the diagnosis of errors in the refrigeration system, the computer system monitoring the electrical load being sent to the compressors may be calibrated to identify various changes in the energy profiles during operation of the refrigeration system. Changes in the energy profile curves for known events may indicate faulty or improperly working components of the refrigeration system. For instance, as the compressor becomes older or less efficient, more energy may be needed to reduce the temperature inside the temperature controlled compartment. Embodiments of the computer system may apply an algorithm calculating the reduction in efficiency of the compressor over time and adjust the energy profiles accordingly.

In some instances, components of the refrigeration system (other than the compressor) may impact the energy profiles or trigger events that may be used to diagnose technical errors with the refrigeration system. For example, a faulty or worn seal in the door of the temperature controlled compartment may result in a slow leak of cold air. Faster, more periodic bursts of electrical energy to re-cool an undisturbed compartment may indicate to a user monitoring system that a leak is occurring when the door is shut.

### System for Monitoring Activity of a Temperature Controlled Compartment

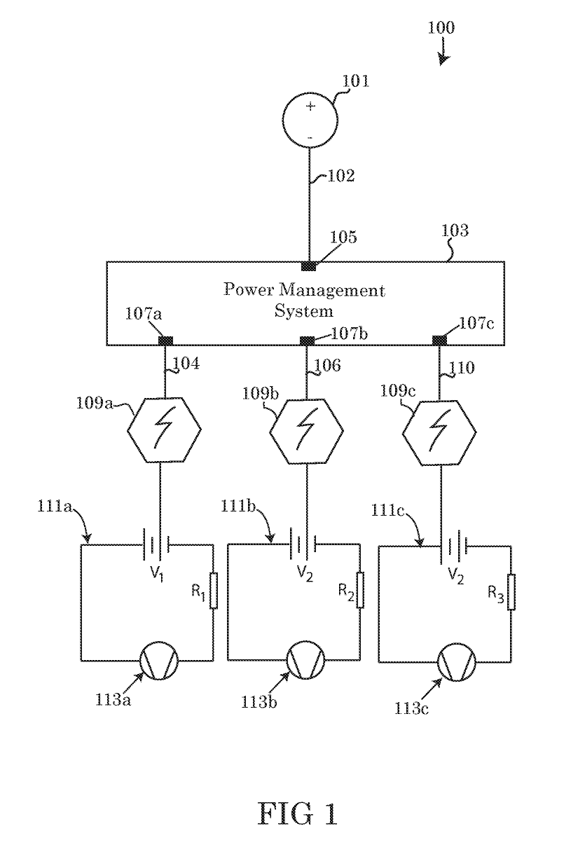

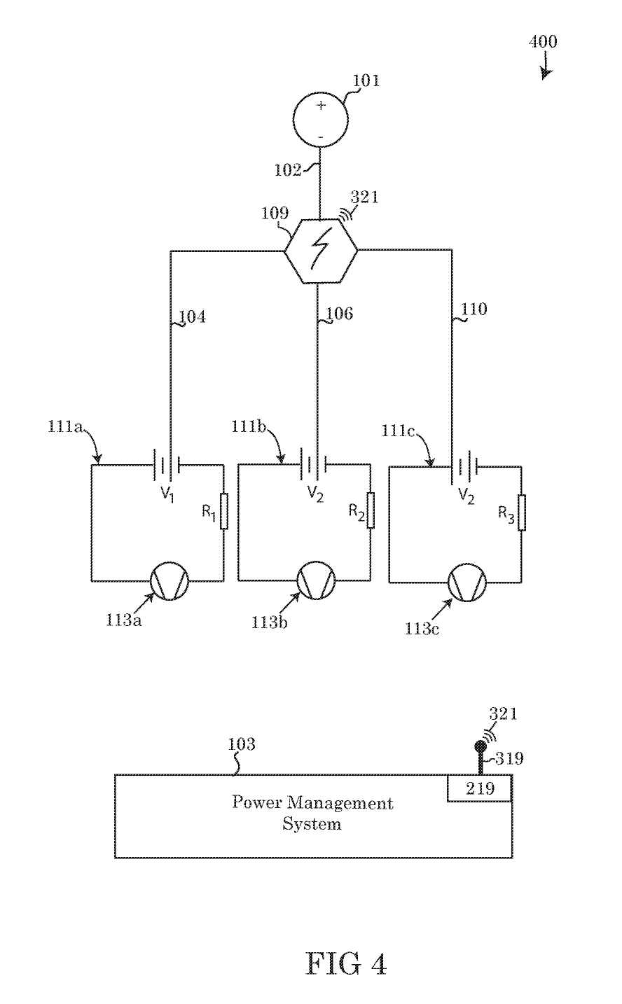

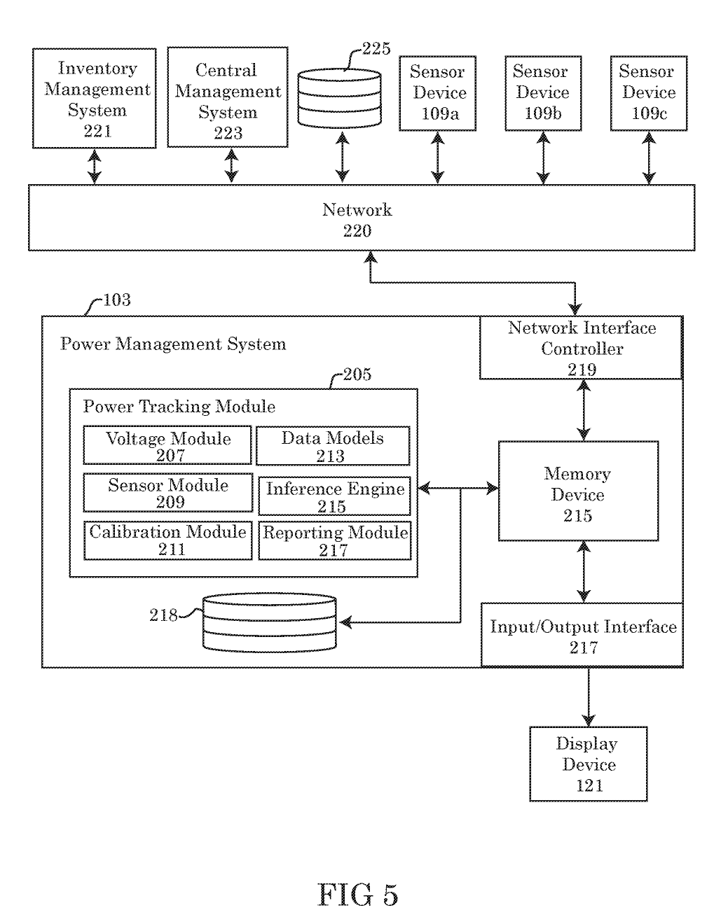

Referring to the drawings, FIG. 1 illustrates a schematic diagram of a system 100, for monitoring the activity of a temperature controlled compartment, consistent with the disclosure of this application. Embodiments of system 100 may comprise one or more specialized computer systems 103, 109a, 109b, 109c having specialized configurations of hardware, software or a combination thereof as depicted in FIGS. 1-5 and as described throughout the present disclosure. Embodiments of the computer systems 103, 109a, 109b, 109c may further comprise one or more elements of the generic computer system 800 of FIG. 8, described in detail below. The elements of the generic computer system 800 may be integrated into each of the specialized computer systems 103, 109a, 109b, 109c described herein.

Embodiments of the system 100 for monitoring the activity of a temperature controlled compartment may comprise one or more of the elements described in this application. The elements may comprise a combination of an electrical source 101, a power management system 103, one or more sensor devices 109a, 109b, 109c (also referred hereafter as “sensor device 109”), one or more compressor circuits 111a, 111b, 111c (also referred hereafter as “compressor circuit 111”) and/or one or more compressors 113a, 113b, 113c (also referred hereafter as “compressor 113”).

Embodiments of an electrical source 101 may be any type of electrical energy that may be used to deliver electrical power across the compressor circuits 111 and energize each of the compressors 113 of the system 100. The electrical source 101 may provide a direct current (DC) or an alternating current (AC) to each of the components within the monitoring system 100. Whether a DC or AC electrical source 101 is used may depend on the location of the nearest electrical source, the type of electrical source 101 used and the types of the compressors 113 (AC or DC) integrated into the system. In the exemplary embodiment, the electrical source 101 may be wired throughout a building such as a store, home or retail location and the current may be accessible to the system 100 via one or more electrical outlets acting as the electrical source 101. Alternatively, in some embodiments, the electrical source 101 may include one or more AC or DC generators connected to the system 100.

In some embodiments, the electrical source 101 may be connected to a power management system 103 via a first conduit 102. A “conduit” may refer to any tube, pipe, channel, duct, etc. carrying and protecting electrical wires or cables passing through the conduit. In the embodiment shown in FIG. 1, the first conduit 102 may extend from the electrical source 101 into an input 105 of the power management system 103. The electrical energy supplied by the electrical source 101 may pass through or be directed by the power management system 103 to one or more compressor circuits 111 that may draw the electrical energy from the electrical source 101 in order to power the attached compressor 113. In some embodiments, the electrical energy passing or being directed by the power management system 103 may exit the power management system via one or more electrical outputs 107a, 107b, 107c (hereinafter referred to as “electrical output 107”). The electrical energy exiting the power management system 103 may exit from the appropriate electrical output 107 via a second conduit 104, 106, 110. Embodiments of the second conduit 104, 106, 110 may direct the flow of electrical energy from the power management system 103 to the corresponding compressor circuit 111 that is drawing the electrical energy from the electrical source 101. For example, if compressor 113a is drawing the electrical energy, the electrical energy may be directed from electrical output 107a to a second conduit 104 that is connected to the compressor circuit 111a wherein the compressor 113a is connected thereto. Likewise, if compressor 113b is drawing the electrical energy, the electrical energy passing through the power management system 103 may exit the power management system 103 via electrical output 107b into the second conduit 106.

In some embodiments of the system 100, the second conduits 104, 106, 110 may be equipped with a sensor device 109 connected or integrated into the conduit 104, 106, 110. The sensor device 109 may measure the amount of electrical energy passing from the electrical source through the conduit toward the respective compressor circuit 111 that is connected to the second conduit 104, 106, 110. In the exemplary embodiment, the sensor device 109 may be a voltage sensor or a current sensor capable of monitoring the voltage V1, V2, V3 or current of the electrical load being passed to the compressor 113. Embodiments of the sensor device may convert the voltage, current or other measurable property of the electrical source 101 between two points of the electrical circuit of the system 100. The measurement of the measurable property of the electrical source 101 may be converted into a physical signal proportional to the electrical properties of the electrical load passing through the system 100 toward the compressor circuit 111. In the exemplary embodiment, the sensor device 109 may be a voltage sensor which may convert the voltage measured between two points in the system 100 to create a physical signal proportional to the voltage. The physical signal generated by the voltage sensor may be transmitted back to the power management system 103 for further analysis as described in this application.

Each compressor circuit 111 receiving electrical energy from the electrical source 101 may comprise one or more compressors 113 connected to the compressor circuit. Embodiments of each compressor may further be connected with or placed into thermal communication with one or more refrigeration systems and/or the temperature controlled compartments of the refrigeration system. Many types of compressors 113 may be suitable for the system 100. The compressor 113 that may be utilized may include any type of compressor that is suitable for refrigeration, cooling, freezing or maintaining a desired temperature inside a temperature controlled compartment that is less than the ambient temperature outside of the temperature controlled environment. For example, the compressor 113 may be any type of gas compressor including reciprocating, rotary screw, centrifugal, scroll compressor, diaphragm, axial-flow, diagonal flow, mixed flow, liquid ring or any other type known in a person skilled in the art of gas compression and refrigeration.

Embodiments of the compressor 113 may be described as being open, hermetic or semi-hermetic compressors 113. In a hermetic or semi-hermetic compressors, the compressor and motor driving the compressor 113 may be integrated, and operate within the refrigerant system. The motor may be hermetic and designed to operate, and be cooled by, the refrigerant being compressed. Conversely, an open compressor may have a motor drive which is outside of the refrigeration system, and provides drive to the compressor 113 by means of an input shaft with gland seals. Open compressor motors may be air-cooled and may be more easily exchanged or repaired without degassing of the refrigeration system.

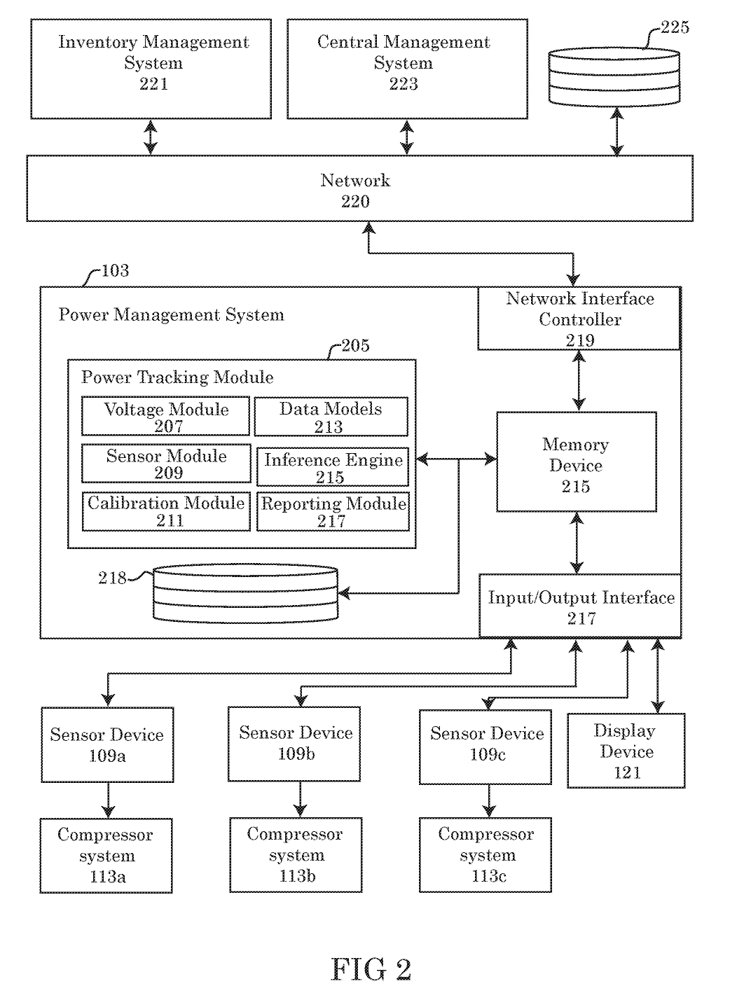

Referring to the drawings, FIG. 2 depicts a block diagram describing additional details of the embodiment of system 100. In particular, the drawing of FIG. 2 depicts greater details about the architecture of the power management system 103, as well as the input/output (10) interface 217 between the power management system 103 and the sensor devices 109. FIG. 2 further depicts embodiments of network connectivity between the power management system 103 and other computer systems 221, 223 or hardware devices 225 that may be in communication with the power management system 103 over the computer network 120.

Embodiments of the power management system 103 may be a specialized computer system which may include specialized hardware and software loaded in the memory device 215. The power management system 103 may include one or more of the components of the generic computer system described below, including a processor 891, memory device 894, 895, an input device 892, output device 893 and/or a read only memory device 899 or firmware. Embodiments of the specialized hardware and/or software of the power management system 103 performing the monitoring the activity of the temperature controlled compartment may be part of the power tracking module 205. The hardware and software components may include a voltage module 207, sensor module 209, calibration module 211, data models 213, inference engine 215 and reporting module 217. The term “module” may refer to a hardware module, software-based module or a module may be a combination of hardware and software resources of the power management system 103 and/or resources remotely accessible to the power management system 103.

Embodiments of the modules described in this application, whether comprising hardware, software or a combination of resources thereof, may be designed to implement or execute one or more particular functions, tasks or routines of the computer system incorporated therein. Embodiments of hardware-based modules may include self-contained components such as chipsets, specialized circuitry and one or more memory devices. A software-based module may be part of a program code or linked to program code or computer code 897, 898 containing specific programmed instructions loaded into the memory device 215 of the respective computer system, such as the power management system 103, and/or a remotely accessible memory device (not shown) of a network accessible computer system. For example, a web server, application server, inventory management system 221 or central management system 223.

Embodiments of the power management system 103 may comprise a power tracking module 205, which may be responsible for receiving, controlling and distributing the voltage from the electrical source 101 to the compressor circuit 113, retrieving sensor data from each of the sensor devices 109 positioned within the system 100, calibrating one or more different events characterized by the electrical load received from the electrical source, analyzing the electrical activity against known data models of known electrical events, drawing logical conclusions based on the analysis and reporting the results to a user. Embodiments of the power tracking module 205 may include one or more sub-modules designated to perform one or more specific tasks or routines assigned to the power tracking module 205. In some embodiments of system 100, the power tracking module 205 may include a voltage module 207, sensor module 209, calibration module 211, one or more data models 213, an inference engine 215 and a reporting module 217.

The voltage module 207 may perform the task of converting a fixed voltage or fixed frequency electrical input into a variable voltage that may be delivered to a resistive load. For example, voltage module 207 may deliver fixed or variable voltage to the compressor circuit 111 having a resistor such as resistor R1, R2 or R3 and compressor 113 connected thereto. In the exemplary embodiment of the system 100, wherein the electrical source provides an AC current, the voltage module 207 may be an AC voltage controller or AC regulator. Embodiments of the voltage module 207 may operate in two different manners. The voltage module 207 may be an on-and-off controller or may operate as a phase controller. When operating as an on-and-off controller, the voltage module may be used as an AC switch. Alternatively, in some embodiments, the voltage module may regulate the electrical source's 101 distribution of the electrical energy as the energy is directed to the compressor circuits 111 using phase angle control. By controlling the phase angle, the output RMS voltage of the load can be varied.

Embodiments of the power management system 205 may further comprise a sensor module 209. The sensor module 209 may receive and process sensor data collected by each sensor device 109 connected to the power management system 205. The sensor module 209 may interpret physical signals interpreted by each sensor device 109 receiving a voltage from the power management system 103. Embodiments of the sensor module 209 may collect and store the sensor data in one or more data repositories 218 or network accessible data repositories 225 for further processing at a later time by the calibration module 211 or inference engine 215. In some embodiments, the sensor module 209 may also communicate with each sensor module to send commands or instructions to the sensor devices 109. For example, commands to report or set a particular status state may be performed by the sensor module 209. In other embodiments, the sensor module 209 may instruct the sensor devices 109 to transmit collected sensor data stored by each of the sensor devices 109 at a particular time, interval or continuously.

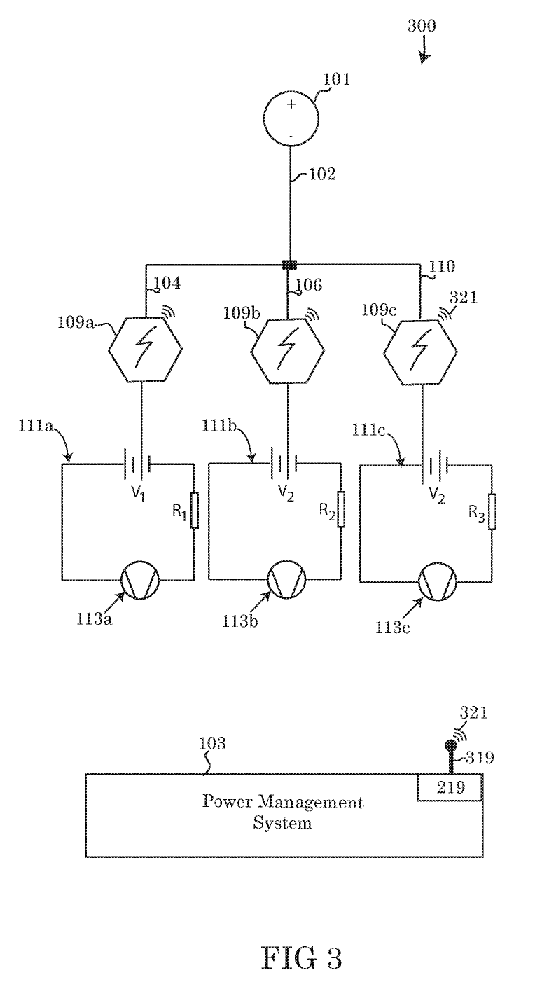

In some embodiments of the power management system 103, the sensor module 209 may communicate over physical connections between the sensor devices 109 and the power management system 103 via the I/O interface 217. The I/O interface 217 may refer to any communication process performed between the power management system and the environment outside of the power management system, for example, the sensor devices 109. The input data (such as the sensor data) received by the I/O interface 217 may be stored in a computer readable memory device or medium such as memory device 215. In alternative embodiments, including those embodiments depicted in FIGS. 3-5, the power management system 103 may communicate using wireless signals 321 between the power management system's 103 transceiver 319 a receiver or transceiver built into the sensor device 109. The power management system 103 placed into wireless communication with each of the sensor devices 109 may communicate over computer network 220 instead of the I/O interface 217 in some embodiments.

In some embodiments of the power management system 103, the power tracking module 205 may include a calibration module 211. The calibration module 211 may perform the steps of calibrating the power management system 103 to identify and learn specific events from the patterns of electrical load drawn by the compressors 113. Learning each type of event that may occur from the patterns of electrical load sent to the compressors may allow for the power management system 103 to evaluate and monitor the activity for each refrigeration system, customer trends and the health of the refrigeration systems. Embodiments of the calibration module 211 may create and store known energy profiles of known events that may affect the electrical load drawn by the compressors. Each known event having a corresponding energy profile may be stored as a data model 213 in the memory device 215, data repository 218 or networked data repository 225.

In some embodiments of the system 100, the calibration module 211 may place the power management system 103 into a learning mode. Once in learning mode, a user of the system may simulate different types of events in order to create and store energy profiles for each type of event that may be experienced by the refrigeration system. For instance, a user may simulate events such as deliveries, improperly closed refrigeration system doors, customers opening and closing the refrigeration doors at various rates or lengths of time, improperly sealed doors, and any other type of event that may be experienced by a refrigeration system.

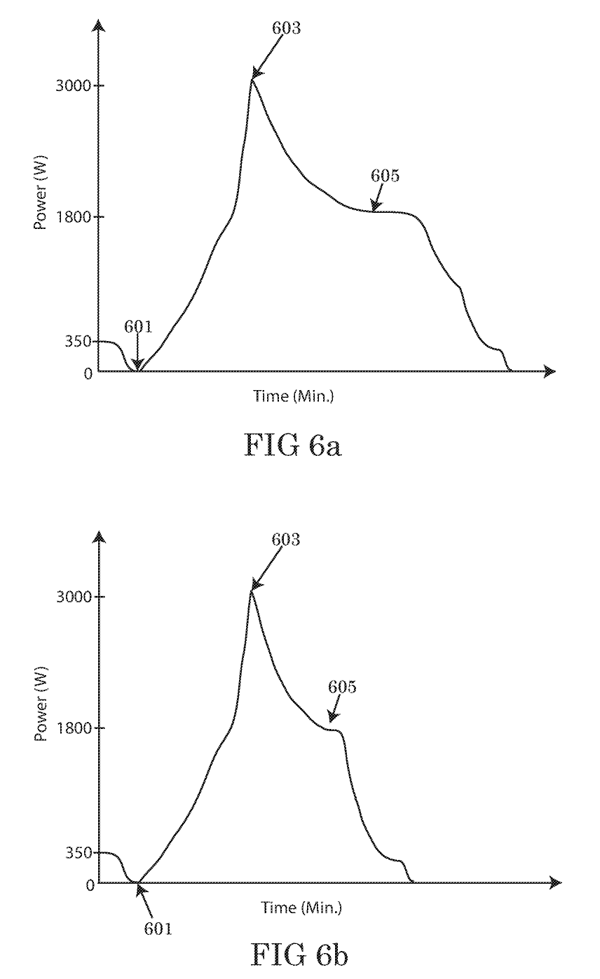

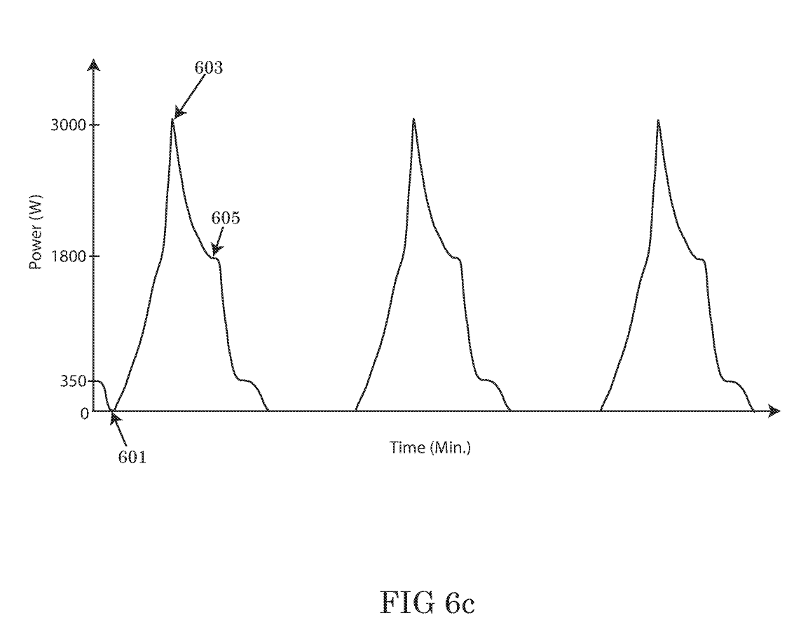

During the simulations of each event, the calibration module 211 may retrieve sensor data from the sensor module 209. The calibration system may use the sensor data to plot an energy profile for the simulated event as a function of the electrical power drawn by the compressor 113 over a period of time. FIGS. 6a-6c provide prophetic examples of three different energy profiles for different events simulated by the system 100 in learning mode. The example energy profiles in FIGS. 6a-6c include a delivery in FIG. 6a, a customer interacting with the door of the refrigeration system in FIG. 6b and an improperly closed door in FIG. 6c.

In the examples provided, the compressor 113 for the simulations was used having a peak electrical load 603 of 3000 W (3 kW) during an initial startup phase, measured from rest 601 to the peak electrical load 603. This measurement may be referred to as a “startup phase”. The compressors 113 used for the examples also maintained an equilibrium phase 605 of approximately 1800 W (1.8 kW) while running, to continuously reduce the temperature inside the temperature controlled compartment of the refrigeration system after the initial startup phase. The system 100 is not limited to the particular compressor shown by specific examples. The energy profiles and the compressors 113 used are for illustrative and explanative purposes.

The embodiment of the event calibrated by the calibration module in FIG. 6a was directed toward a delivery, approximately 20 minutes in length. During the simulated delivery, the door sealing the temperature controlled compartment of the refrigeration system was opened while the delivery commences. During the simulated event, not only was heat from outside of the temperature controlled compartment entering the interior of the temperature controlled compartment, but also refrigerated items were introduced into the temperature controlled compartment may have been warmer than the temperature pre-set temperature of the refrigeration system. Accordingly, the compressor connected to the temperature controlled compartment receiving the delivery may initiate once the temperature dips below the baseline temperature maintained within the temperature controlled compartment.

Upon initiation of the compressor 113, the sensor devices 109 may measure an electrical load received by the compressor 113 during the startup phase of the compressor 113. In this particular example, the startup phase was between the resting point 601 and the peak 603. Once the compressor 113 has completed the startup phase, the sensor devices 109 measure a reduction in the electrical load being sent to the compressor 113 until an equilibrium 605 is met. During the equilibrium phase, the compressor may receive a constant electrical load from the electrical source 101 until the established baseline temperature is met. Subsequently, after re-establishing the baseline temperature inside the temperature controlled compartment, the electrical load sent to the compressor 113 may be reduced or cease, causing the compressor 113 to return to the off state. The steps described for measuring the compressor's 113 draw of electrical load, as described above was repeated for both a customer opening/closing the refrigeration system's door shown in FIG. 6b and for an improperly closed door in FIG. 6c.

Each of the simulated events measured by the calibration module 211 depict some defining features that may be used to differentiate from one another when the events occur in real time. For example, in FIG. 6a, the calibration module 211 measure a delivery event having an energy profile that is long, drawn out and has an extended equilibrium phase 605. The extended equilibrium phase 605 is consistent with the extended period of time wherein the refrigeration door is open while an employee is stocking the temperature controlled compartment.

Conversely, the energy profile in FIG. 6b, directed toward a customer opening the door of the refrigeration system has a much shorter equilibrium phase 605 than the delivery's energy profile. Much less heat may enter the temperature controlled compartment when customers are opening the door for a limited period of time, selecting a product and returning the door of the refrigeration system to the closed position. Moreover, multiple customers opening and closing the doors over a period of time may reveal inconsistently random spikes in the energy profile where the compressor enters the on state again. This may be due to the random nature of customers selecting products stored within the refrigeration system. The random spikes in the energy profile that may be experienced at random times may be different from an improperly closed refrigeration door, shown in FIG. 6c, which may (when left undisturbed) display sharp and quick spikes in the energy profile at consistently similar intervals of time in between the spikes in the electrical load.

Embodiments of the power management system 103 may, in some embodiments include an inference engine 215. The inference engine 215 may be a processing program that derives a conclusion from the facts and rules contained in the knowledge base using various artificial intelligence techniques. In the system 100, the inference engine 215 may draw conclusions as a function of comparing data models of the known energy profiles collected by the calibration module 211 during the learning mode with one or more data models of sensor data collected by the sensor devices 109 while the system 100 is actively monitoring the consumption of the electrical load drawn by the compressors 113. Embodiments of the inference engine may analyze the data points of the data models 213 comprising one or more energy profiles with real time sensor data being collected. As a function of the analysis of the similarities between unknown energy profiles and the known energy profile data models 213, the inference engine 215 may draw a conclusion about the type of event that may have occurred either recently or in real time.

The conclusions drawn by the inference engine 215 may be stored within a local repository 218 and/or a network accessible repository 225 in some embodiments of system 100. In some embodiments, the power management system 103 may include a reporting module 217. The reporting module 217 may be responsible for performing the task of generating and delivering reports about the various events and activities of the refrigeration system being monitored. The reporting module 217 may generate reports that may be displayed by the display device 121, which may allow a user operating the power management system to review recent events, refrigeration activity, as well as evaluate the overall health of the compressor and/or system 100. In some embodiments of the system 100, the user may utilize the reports to verify that one or more particular events has occurred. For example, a user may confirm that a delivery to the refrigeration system has or has not occurred as scheduled. Moreover, a user may also track the occurrences of customer activity at each refrigeration system, identify the busiest times of day, and may determine the most popular products stored by the refrigeration system by cross referencing the identified events with an inventory list or purchase data.

In some embodiments of system 100, the reporting module 217 may not only generate a report on the activity of the monitored refrigeration systems for local display on a display device 121. The reporting module 217 may additionally provide a report to other computer systems connected to the same computer network 220. Embodiments of the network 220 may be constructed using wired or wireless connections between each hardware component connected to the network 220. As shown in the exemplary embodiments, each of the computer systems 103, 221, 223 may connect to the network 220 and communicate over the network 220 using a network interface controller (NIC) 219 or other network communication hardware. Embodiments of the NICs 219 may implement specialized electronic circuitry allowing for communication using a specific physical layer and a data link layer standard such as Ethernet, Fiber channel, Wi-Fi or Token Ring. The NIC 219, may further allow for a full network protocol stack, enabling communication over network 220 to the group of computer systems or other computing hardware devices linked together through communication channels. The network 220 may facilitate communication and resource sharing among the computer systems 103, 221, 223 and additional hardware devices connected to the network 220, for example a network repository 225 and network enabled sensor device 109. Examples of a network 220 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

Additional computer systems that may receive one or more reports transmitted by the reporting module 217, may include an inventory management system 221 and a central management system 223. Embodiments of the inventory management system 221 may include any type of computer system used for tracking and monitoring inventory. For example, an inventory system may monitor each individual product available for sale in a store. An inventory management system may utilize the reports describing the activities of each monitored refrigeration system to further improve the efficiency of the store. For instance, the inventory management system may use the conclusions about customer trends and the most popular refrigeration systems in the store to create and implement restocking protocols as a function of a refrigeration system's activity. By combining the monitoring activity of the power management system 103 with the inventory information of the inventory management system 221, the system 100 may timely manage inventory in each refrigeration system in the store and ensure that the temperature controlled compartments are restocked in a timely manner or in anticipation of known customer trends.

In some embodiments of system 100, the reporting module 217 may transmit information regarding the activity and events of each refrigeration system to a central management system 223 connected to network 220. The central management system 223 may be a central node of a storewide network. Each store equipped with the monitoring system 100 as described herein may report the activity of each refrigeration system within the store the central management system 223. Accordingly, the central management system 223 may aggregate the information from each store and determine general trends in customer activity, times where each store is busiest, the most popular products as a function of the most popular refrigeration systems by region or territory and determine the most popular stores in the storewide network.

Referring to the drawings, FIG. 3 provides an alternative embodiment 300 of system 100. As exemplified by the drawing, in the alternative embodiment 300, the electrical energy may not travel from the energy source 101 via conduit 102 to the power management system 103. Instead, the electrical load being drawn by a compressor may travel from the first conduit 102 to a second conduit 104, 106, 110 comprising one of the sensor devices 109. The sensor devices 109 may be equipped with a transmitter or transceiver and remotely transmit the sensor data describing the electrical load measured by the sensor device 109 to the power management system 103, as the electrical load is drawn to the compressor circuit 111. Each sensor device may remotely. As shown in the alternative embodiment of FIG. 3, a sensor device 109 may be installed on the second conduit 104, 106, 110 connected to a compressor circuit 111. In yet another alternative embodiment 400, a single centralized sensor device 109 may measure the flow of electrical energy to each of the compressor circuits 111 in a bank of refrigeration systems. The sensor device 109 may measure the various electrical loads and which compressor 113 is drawing the load from the electrical source 101. Similar to the sensor devices 109 of FIG. 3, the sensor device 109 in embodiment 400 may also transmit the collected measurements and data wirelessly to a power management system 109 receiving the sensor data via the wireless transceiver 319.

### Method for Monitoring the Activity of a Temperature Controlled Compartment

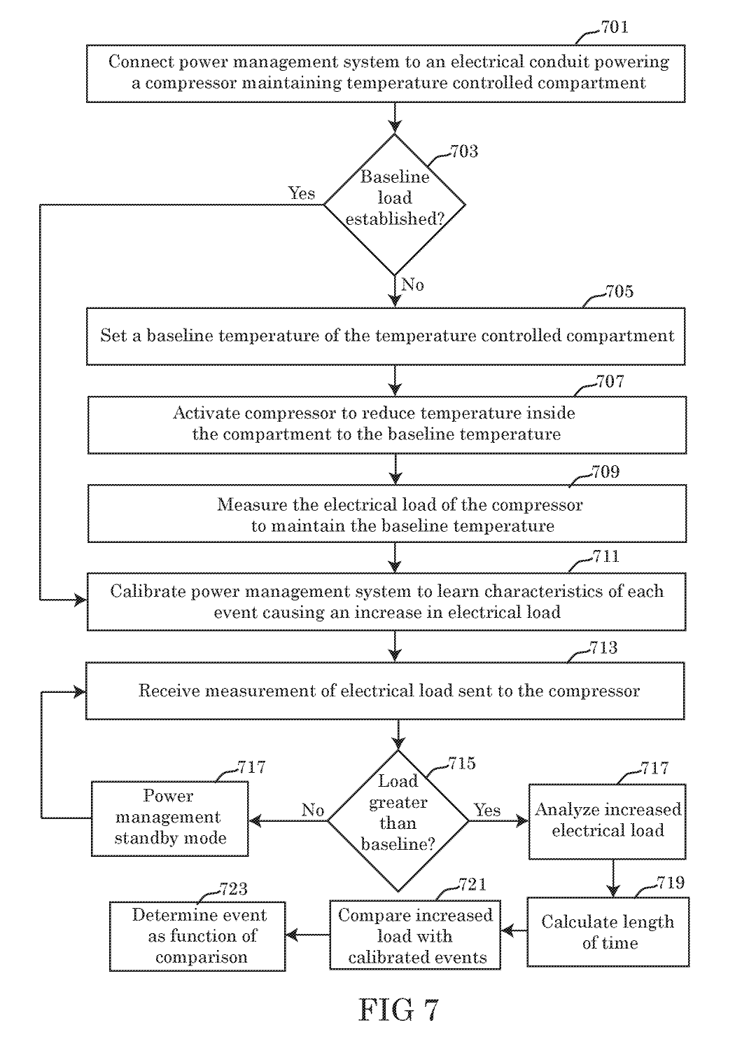

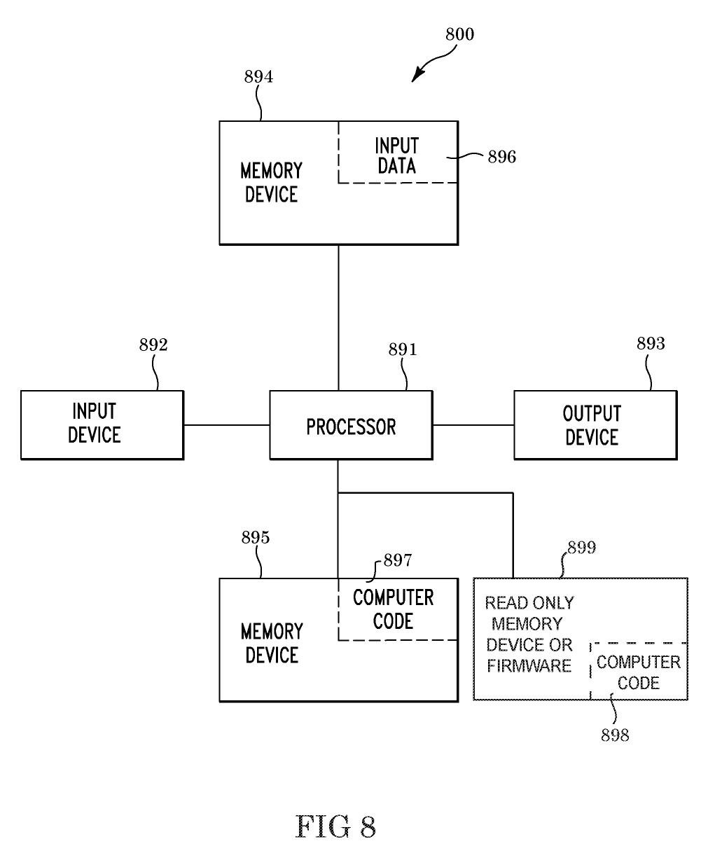

The drawing of FIG. 7 represents an embodiment 700 of a method or algorithm that may be implemented for monitoring the activity of a temperature controlled compartment of a refrigeration system in accordance with the systems described in FIG. 1-6c using one or more computer systems defined generically in FIG. 8 below, and more specifically by the specific embodiments depicted in FIG. 1-6c. A person skilled in the art should recognize that the steps of the algorithm described in FIG. 7 may not require all of the steps disclosed herein to be performed, not does the algorithm of FIG. 7 necessarily require that all the steps be performed in the particular order presented. Variations of the method steps presented in FIG. 7 may be performed, wherein one or more steps may be performed in a different order than presented by FIG. 7.

The algorithm described in FIG. 7 may initiate in step 701, wherein the power management system 103 and/or sensor devices 109 may be connected to an electrical conduit 102, 104, 106, 110 powering a compressor 113 responsible for maintaining a temperature controlled compartment of a refrigeration system. In the exemplary embodiment, the step of connecting the power management system 103 may be performed by attaching a first conduit 102 to an input 105 of the power management system's 103 I/O interface 217. Moreover, one or more additional conduits 104, 106, 110 may be attached to one or more electrical outputs of power management system's 113 I/O interface 217. The number of conduits attached to the I/O interface may vary depending on the number of refrigeration systems being monitored by the power management system 103.

In step 703, a determination may be made by the power management system 103 regarding whether or not a baseline load may be established for the refrigeration system 703. The baseline load may refer to the electrical load received from the electrical source 101 in order to maintain the temperature of the temperature controlled compartment during undisturbed conditions. If, the power management system 103 has established a baseline load previously for each component connected to the system 100, 300, 400, the power management system 103 may proceed to step 711 (described below). Conversely, if a baseline load for each compressor 113 of the system 100, 300, 400 in the current configuration has not yet been established, the method may proceed to step 705. In some embodiments, the baseline load may be established for some of the compressors 113, for systems having a previous configuration or previous components. However, periodically equipment within the embodiments of system 100, 300, 400 may be replaced, including compressors 113, sensor devices, refrigeration seals, doors, thermostats and even entire refrigeration units. Under such circumstances where an entire configuration has not been evaluated to determine a baseline electrical load, the method may proceed to step 705. In alternative embodiments, the method may only proceed to step 705 if the compressor or another large component of the system 100, 300, 400 has not previously been configured.

In step 705, a baseline temperature within the temperature controlled compartment may be set. Step 705 may be performed configuring a desired temperature of a thermostat measuring the temperature inside the temperature controlled compartment. Alternatively, a baseline temperature may be set by designating a desired pressure inside the evaporator of the refrigeration system. The baseline temperature may be the temperature that the system 100, 300, 400 has set to be maintained for the purposes of storing products and other items held within the temperature controlled compartment.

Subsequently, in step 707 of the method, the compressor 113 may be activated, reducing the temperature inside the temperature controlled storage compartment to the desired baseline temperature set by the system 100, 300, 400 in step 705. The electrical load being delivered to the compressor 113 and the compressor circuit 111 may be measured in step 709 by one or more sensor devices 109. In the exemplary embodiment, the sensor device 109 may measure the voltage across the conduit 104, 106, 109 leading to the compressor circuit 111. The measurement for the purposes of establishing the baseline electrical load for maintaining the baseline temperature may be performed during a time when the refrigeration system will be undisturbed by a third party. For example, the establishment of the baseline load may be performed while the refrigeration system is inaccessible to customers or during hours while a store comprising the refrigeration system is closed. Once the baseline load for maintaining the baseline temperature has been established, the energy profile and electrical load requirements may be saved or stored to the memory device 215, one or more data repositories 218, 225 and/or the data models 213 stored by the power tracking module 205 of the power management system 103.

Once the measurements of the baseline load have been established, the method may, in step 711 calibrate the system 100, 300, 400, including the power management system 103 to learn the characteristics of one or more events that cause an increase in the electrical load above the baseline load established in steps 705, 707 and 709. The power management system 103 may be automatically calibrated or manually calibrated in some embodiments. Automatic calibration may be performed by downloading one or more stored known energy profiles previously measured by one or more power management systems having similar specification. The downloaded energy profiles may be saved to the memory device 215, data models 213 or other data repositories 218, 225 and recalled by the inference engine at a later point in time. Alternatively, users or administrators of the power management system 103 may calibrate the system 100, 300, 400 by manually simulating one or more events that may result in an increase in the electrical load above the baseline load in order to reduce the temperature back to the baseline temperature.

During the simulations of each event, sensor data of the electrical loads being drawn by the compressors 113 may be measured by each sensor device 109. The sensor data may be shared by the sensor module 209 with the calibration module 211. The calibration module 211 may aggregate the sensor data as a function of the electrical load drawn by the compressors 113 and time. The energy profiles may be stored by the power management system 103 and analyzed against actual event data for unknown events that cause an increase in electrical load in order to determine the type of unknown event that has occurred.

In step 713, the power management system 103 may receive a measurement of the electrical load being sent from the electrical source 101 to the compressor 113. The measurement performed in step 713 may be measured by one or more sensor devices 109 and transmitted via wired or wireless transmission to the power management system 103 for storage and analysis by the inference engine 215. In step 715, the inference engine 215 determines whether the electrical load measured by the sensor devices in step 713 is greater than the baseline load for maintaining the baseline temperature of the temperature controlled compartment. If the load does not exceed the baseline load, the power management system 717 remains in standby mode as the power management system 717 continues to monitor the changes in electrical load detected by the sensor devices 109.

Changes in the electrical load that are less than or equal to the baseline load may be attributed to the maintenance of the temperature within the temperature controlled compartment. It should be understood that even the best sealed compartment will experience an increase in temperature within the controlled compartment, so long as the temperature outside of the compartment is warmer than the temperature inside the compartment. Minimal amounts of power being provided to the compressor 113 may be an indication of maintaining the baseline temperature instead of experiencing an event that relies on a greater change in the amount of electrical load in order to re-equilibrate the temperature controlled compartment back to the baseline.

Conversely, if the electrical load measured by the sensor devices 109 is greater than the baseline established in steps 705, 707 and 709, the inference engine 215 may analyze the sensor data collected by the sensor module 209. During the analysis of step 719 the inference engine may create an energy profile for the unknown event by plotting the electrical loads as a function of the time calculated in step 721. Subsequently, once the electrical load has been plotted as an energy profile, in step 723 the inference engine 215 may compare the energy profile of the unknown event against known energy profiles corresponding to known events calibrated by the power management system in step 709 of this method. In step 725, the inference engine 215 may draw conclusions based on the comparison performed in step 723 and determine the type of event experienced as a function of the comparison. Furthermore, the reporting module 217 of the power management system 103 may generate a report describing the source of the event leading to the influx of electrical load being delivered to the compressor 113.

In some embodiments, the method for monitoring the activity of a temperature controlled compartment may further comprise the steps of verifying the event causing the increase in the amount of electrical load being drawn by the compressor. For example, in some embodiments of the system 100, 300, 400, the power management system may be connected via the I/O interface 217 or via network 220 to a camera system or digital recording system. The camera or digital recording system may collect video data of the refrigeration system. The collected video data may be transmitted from the camera system to the power management system for storage of the video verification data. In alternative embodiments, the video verification data may be transmitted over network 220 to a network accessible repository 225, the control management system or the inventory management system.

### Computer System

Referring to the drawings, FIG. 8 illustrates a block diagram of a computer system 800 that may be included in the systems of FIGS. 1-5 and for implementing methods for monitoring activity of a temperature controlled compartment as shown in the embodiment of FIG. 7 and in accordance with the embodiments described in the present disclosure. The computer system 800 may generally comprise a processor 891, otherwise referred to as a central processing unit (CPU), an input device 892 coupled to the processor 891, an output device 893 coupled to the processor 891, and memory devices 894 and 895 each coupled to the processor 891. The input device 892, output device 893 and memory devices 894, 895 may each be coupled to the processor 891 via a bus. Processor 891 may perform computations and control the functions of computer 800, including executing instructions included in the computer code 897 for tools and programs for monitoring activity of a temperature controlled compartment, in the manner prescribed by the embodiments of the disclosure using the systems of FIGS. 1-4 wherein the instructions of the computer code 897 may be executed by processor 891 via memory device 895. The computer code 897 may include software or program instructions that may implement one or more algorithms for implementing the methods for monitoring activity of a temperature controlled compartment, as described in detail above. The processor 891 executes the computer code 897. Processor 891 may include a single processing unit, or may be distributed across one or more processing units in one or more locations (e.g., on a client and server).

The memory device 894 may include input data 896. The input data 896 includes any inputs required by the computer code 897, 898. The output device 893 displays output from the computer code 897, 898. Either or both memory devices 894 and 895 may be used as a computer usable storage medium (or program storage device) having a computer readable program embodied therein and/or having other data stored therein, wherein the computer readable program comprises the computer code 897, 898. Generally, a computer program product (or, alternatively, an article of manufacture) of the computer system 800 may comprise said computer usable storage medium (or said program storage device).

Memory devices 894, 895 include any known computer readable storage medium, including those described in detail below. In one embodiment, cache memory elements of memory devices 894, 895 may provide temporary storage of at least some program code (e.g., computer code 897, 898) in order to reduce the number of times code must be retrieved from bulk storage while instructions of the computer code 897, 898 are executed. Moreover, similar to processor 891, memory devices 894, 895 may reside at a single physical location, including one or more types of data storage, or be distributed across a plurality of physical systems in various forms. Further, memory devices 894, 895 can include data distributed across, for example, a local area network (LAN) or a wide area network (WAN). Further, memory devices 894, 895 may include an operating system (not shown) and may include other systems not shown in the figures.

In some embodiments, rather than being stored and accessed from a hard drive, optical disc or other writeable, rewriteable, or removable hardware memory device 894, 895, stored computer program code 898 (e.g., including algorithms) may be stored on a static, non-removable, read-only storage medium such as a Read-Only Memory (ROM) device 899, or may be accessed by processor 891 directly from such a static, non-removable, read-only medium 899. Similarly, in some embodiments, stored computer program code 897 may be stored as computer-readable firmware 899, or may be accessed by processor 891 directly from such firmware 899, rather than from a more dynamic or removable hardware data-storage device 895, such as a hard drive or optical disc.

In some embodiments, the computer system 800 may further be coupled to an Input/output (I/O) interface and a computer data storage unit (for example a data store, data mart or repository). An I/O interface may include any system for exchanging information to or from an input device 892 or output device 893. The input device 892 may be, inter alia, a keyboard, a mouse, sensors, beacons, RFID tags, microphones, biometric input device, camera, timer, etc. The output device 893 may be, inter alia, a printer, a plotter, a display device (such as a computer screen or monitor), a magnetic tape, a removable hard disk, a floppy disk, etc. The memory devices 894 and 895 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 800, and may include any type of transmission link, including electrical, optical, wireless, etc.

The I/O interface may allow computer system 800 to store information (e.g., data or program instructions such as program code 897, 898) on and retrieve the information from a computer data storage unit (not shown). Computer data storage units include any known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider able to deploy or integrate computing infrastructure with respect to monitoring activity of a temperature controlled compartment. Thus, an embodiment of the present invention discloses a process for supporting computer infrastructure, where the process includes providing at least one support service for at least one of integrating, hosting, maintaining and deploying computer-readable code (e.g., program code 897, 898) in a computer system (e.g., computer 800) including one or more processor(s) 891, wherein the processor(s) carry out instructions contained in the computer code 897 causing the computer system to monitor the activity of a temperature controlled compartment. Another embodiment discloses a process for supporting computer infrastructure, where the process includes integrating computer- readable program code into a computer system including a processor.

The step of integrating includes storing the program code in a computer-readable storage device of the computer system through use of the processor. The program code, upon being executed by the processor, implements a method for monitoring activity of a temperature controlled compartment. Thus the present invention discloses a process for supporting, deploying and/or integrating computer infrastructure, integrating, hosting, maintaining, and deploying computer-readable code into the computer system 800, wherein the code in combination with the computer system 800 is capable of performing a method of monitoring activity of a temperature controlled compartment.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for monitoring activity of a temperature controlled compartment comprising the steps of:
connecting a computer system to an electrical conduit powering the temperature controlled compartment;
establishing, by the computer system, a baseline electrical load of a compressor maintaining the temperature controlled device at a baseline temperature;
receiving, by the computer system, a measurement of an amount of electrical load sent to the compressor;
detecting, by the computing system, an increase in the amount of electrical load sent to the compressor above the baseline electrical load;
analyzing, by the computer system, the increase in the amount of electrical load sent to the compressor to identify a known energy profile or pattern correlating to a known type of event and calculating a length of time of the increase in the amount of electrical load; and
determining, by the computer system, a type of an event causing the increase in the amount of electrical load sent to the compressor as a function of the analyzing step.

2. The method of claim 1, wherein the temperature controlled compartment is selected from the group consisting of a freezer, refrigerator, cooler and a combination thereof.

3. The method of claim 1, wherein the step of establishing the baseline electrical load of the compressor comprises the steps of:
setting the baseline temperature;
activating the compressor;
reducing the temperature inside the temperature controlled compartment to the baseline temperature; and
measuring, by the computer system, the electrical load of the compressor to maintain the baseline temperature inside an undisturbed temperature controlled compartment for a pre-determined period of time.

4. The method of claim 3, wherein establishing the baseline electrical load further comprises the step of applying an algorithm for calculating a reduction in an efficiency of the compressor over time.

5. The method of claim 1, further comprising the step of calibrating the computer system to identify each known type of event causing the increase in the amount of electrical load sent to the compressor.

6. The method of claim 5, wherein the step of calibrating identifies the type of event selected from the group consisting of stocking the temperature controlled compartment, customer interaction with the temperature controlled compartment, an unclosed door of the temperature controlled compartment and a faulty seal of the temperature controlled compartment.

7. The method of claim 5, further comprising the step of:
verifying, by the computer system, the event causing the increase in the amount of electrical load sent to the compressor.

8. The method of claim 7, wherein the verifying step includes video data verification of the event via a camera system.

9. The method of claim 1, further comprising the steps of:
reporting the event causing the increase in the amount of electrical load to a management system connected to the computer system; and
displaying a report describing the event on a display device of the management system.

10. The method of claim 9, wherein the management system aggregates a plurality of reports describing a plurality of events and electrical load data to predict employee and customer interactions with the temperature controlled compartment.

11. A computer system comprising:
a processor;
a memory device coupled to the processor;
a sensor device coupled to the processor;
a camera system coupled to the processor;
an electrical conduit coupled to the sensor device;
a compressor coupled to the electrical conduit;
a temperature controlled compartment coupled to the compressor; and
a computer readable storage device coupled to the processor, wherein the storage device contains program code executable by the processor via the memory device to implement a method for monitoring activity of the temperature controlled compartment comprising the steps of:
establishing, by the processor, a baseline electrical load of a compressor maintaining the temperature controlled device at a baseline temperature;
receiving, by the processor, a measurement taken by the sensor device measuring an amount of electrical load sent to the compressor;
detecting, by the processor, an increase in the amount of electrical load sent to the compressor above the baseline electrical load;
analyzing, by the processor, the increase in the amount of electrical load sent to the compressor to identify a known energy profile or pattern correlating to a known type of event and calculating a length of time of the increase in the amount of electrical load; and
concluding, by the processor, a type of an event causing the increase in the amount of electrical load sent to the compressor as a function of the analyzing step.

12. The computer system of claim 11, wherein the temperature controlled compartment is a plurality of interconnected freezers.

13. The computer system of claim 11, wherein the step of establishing the baseline electrical load of the compressor comprises the steps of:
setting the baseline temperature;
activating the compressor;
reducing the temperature inside the temperature controlled compartment to the baseline temperature; and
measuring, by the processor, the electrical load of the compressor to maintain the baseline temperature inside an undisturbed temperature controlled compartment for a pre- determined period of time.

14. The computer system of claim 13, wherein establishing the baseline electrical load further comprises the step of applying an algorithm for calculating a reduction in an efficiency of the compressor over time.

15. The computer system of claim 11, further comprising the step;
calibrating the computer system to identify each type of event causing the increase in the amount of electrical load sent to the compressor.

16. The computer system of claim 15, wherein the step of calibrating identifies the type of event selected from the group consisting of stocking the temperature controlled compartment, customer interaction with the temperature controlled compartment, an unclosed door of the temperature controlled compartment and a faulty seal of the temperature controlled compartment.

17. The computer system of claim 15, further comprising the step of:
verifying, by the processor, the event causing the increase in the amount of electrical load sent to the compressor.

18. The computer system of claim 17, wherein the verifying step includes the step of collecting, by the processor, video data verification of the event recorded by the camera system.

19. The computer system of claim 11, further comprising the steps of:
reporting, by the processor, the event causing the increase in the amount of electrical load; and
displaying, by the processor, a report describing the event on a display device coupled to the processor.

20. The computer system of claim 19, further comprising the steps of:
aggregating, by the processor, a plurality of reports describing a plurality of events and electrical load data; and
predicting, by the processor, employee and customer interactions with the temperature controlled compartment.
